(19) United States
(12) Patent Application Publication
(10) Pub. No.: US 2013/0025840 A1
(43) Pub. Date: Jan. 31, 2013

(54) AUXILIARY CONTROLLER FOR AN HVAC SYSTEM AND METHOD OF OPERATION

(71) Applicant: Randall Remme, Blue Mountains (CA)

(72) Inventor: Randall Remme, Blue Mountains (CA)

(21) Appl. No.: 13/556,910

(22) Filed: Jul. 24, 2012

Related U.S. Application Data
(60) Provisional application No. 61/511,246, filed on Jul. 25, 2011.

(51) Int. Cl. G05D 23/19; F24F 11/02

(52) U.S. Cl. 165/237; 236/1 C

(57) ABSTRACT

An auxiliary controller for an HVAC system includes a thermostat interface for receiving control signals by wire from a thermostat; an HVAC system interface for providing control signals by wire to an HVAC system; a security system interface for receiving armed status signals by wire from a security system; and processing structure configured to, while the security system is disarmed, permit routing of all control signals received from a thermostat to an HVAC system and, upon arming of the security system, invoke a setback mode including controlling the routing to reduce energy consumption.

### FIELD OF THE INVENTION

The present invention relates generally to control of heating, ventilation and/or air conditioning (HVAC) systems and more particularly to an auxiliary controller for an HVAC system and a method for controlling an HVAC system.

### BACKGROUND OF THE INVENTION

The general class of environmental control systems known as HVAC (heating, ventilation and air conditioning) systems is well known. Such systems are in common use for heating and/or cooling dwellings such as homes, office buildings, malls, hotel rooms and other interior spaces that are normally occupied by people, and for ventilating the dwellings by circulating heated, cooled or ambient air throughout the home.

For example, a central heating system including a forced air furnace powered by gas, oil or electricity is very commonly incorporated into North American homes, and is typically under the control of a thermostat. The thermostat senses the ambient temperature within a space in the home and either activates or deactivates the furnace to provide or cease heating of air being circulated through the home, in order to maintain a predetermined temperature that is above that outside the home. The thermostat is typically configurable to allow a user to set a particular desired interior temperature. In combination with the furnace itself, the thermostat forms a feedback loop that enables the interior space to be maintained at the desired comfortable temperature by either turning on or shutting off the furnace itself.

Similarly, an air conditioning unit is a very common appliance that, in combination with a thermostat, provides or ceases cooling of air being circulated through a home, in order to maintain a predetermined temperature that is below that outside the home.

While some homes and buildings may incorporate only heating systems, and others may incorporate only air conditioning systems, it is also known to have combined air conditioning and heating systems under the control of a single thermostat, that are configurable to provide either heating control signals to a furnace, or cooling control signals to an air conditioner, depending upon the season and the preferences of the homeowner.

While such HVAC systems—which may be a combination heating/cooling system, just a heating system, or just a cooling system—may be controlled with a simple thermostat that permits the setting of a single temperature at which the air should be maintained by the HVAC system, sophisticated programmable thermostats have long been available. Such programmable thermostats provide numerous functions but all generally enable a homeowner to program various temperature schedules such that the thermostat with thereafter automatically control the HVAC system as programmed. For example, a homeowner may wish to program the programmable thermostat to maintain the temperature of the home at 74 degrees (F.) while people are expected to be in the home, and to maintain the temperature of the home at 80 degrees while people are expected to be at work. In this case, the homeowner might program the programmable thermostat to maintain a temperature of 74 only during evenings, nights and weekends, and to revert to the higher temperature of 80 degrees during the weekday hours of, for example, 7:30 AM to 6:30 PM. As would be understood, during warm summer months an air conditioning unit would not have to work as hard to maintain an internal temperature of 80 degrees, and thus would consume less energy than were the air conditioning unit required to maintain the 74 degree temperature all of the time.

Further options are available to the homeowner using a programmable thermostat. For example, the temperature schedule can further be programmed to lower the air conditioning temperature at night while people are in bed to a comfortable temperature. Or, during cool winter months, the temperature schedule can be programmed to somewhat lower the required temperature at night in the expectation that people can be kept warm by their blankets and not by the central heating system. The programmable thermostat can further be programmed to automatically raise the temperature again at, for example, 6 AM, so that when occupants wake up, the ambient temperature of the house is comfortable for moving about.

While programmable thermostats provide numerous options for energy savings, they are not generally able to accommodate energy savings for unplanned, or ad hoc, absences from the home. For example, during weekends the occupants of a home could have varied activities in and out of the home that are not easy to program into a programmable thermostat, such as trips to the mall, impromptu visits at friends' or families' homes, outings to the movies, and so forth. Such unplanned absences do not submit well to pre-programming temperature schedules. As such, unless the people are certain they will stay home to fully enjoy the programmed environmental conditions, opportunities to reduce the energy consumed by their HVAC systems are being foregone.

It is known to couple motion sensors or other occupancy sensors to thermostatic controllers, in order to cause the thermostatic controllers to invoke an alternative control in the event that motion within a room is not detected, it being implied that the occupants have left the home. However, in the event that the occupant is simply motionless while napping, or watching television, the occupancy sensors will incorrectly imply that the occupant is not there and unfortunately adjust the temperature as though the occupant were not there. Furthermore, in order to effectively implement this in a multi-room home or office space, a large number of such sensors, and complex logic to handle the sensors' respective inputs, would be required. This would be quite expensive and complex to purchase, install and maintain.

Many dwellings incorporate a security system for sounding an alarm or notifying authorities in the event that, while the security system is armed, the dwelling is breached. Such security systems are manually activated and deactivated by occupants when there is to be a change in the occupants' occupancy status.

It is an object of an aspect of the following to provide an auxiliary controller and method for controlling an HVAC system to further reduce the amount of energy consumed by the HVAC system in dwellings incorporating a security system.

### SUMMARY OF THE INVENTION

In accordance with an aspect, there is provided an auxiliary controller for an HVAC system comprising a thermostat interface for receiving control signals by wire from a thermostat; an HVAC system interface for providing control signals by wire to an HVAC system; a security system interface for receiving armed status signals by wire from a security system; and processing structure configured to, while the security system is disarmed, permit routing of all control signals received from a thermostat to an HVAC system and, upon arming of the security system, invoke a setback mode including controlling the routing to reduce energy consumption.

According to another aspect, there is provided a method of operating an auxiliary controller for an HVAC system comprising receiving control signals at the controller by wire from a thermostat; routing all received control signals by wire from the controller to an HVAC system; and in the event that an armed status signal is received by wire at the controller from a security system, invoking a setback mode including controlling the routing to reduce energy consumption.

In general, the auxiliary controller is able to react to the armed status of the security system by controlling the HVAC system in an energy efficient manner when the occupants have clearly indicated their occupancy status via the security system. In particular, the auxiliary controller and method described herein increase the scope of opportunities for reducing HVAC system energy consumption by modifying operation of the HVAC system in response to indications of otherwise unscheduled or ad hoc vacancies from a dwelling.

Furthermore, the ease with which the auxiliary controller described herein can be interconnected to a security system, a thermostat and an HVAC system provide implementation advantages over and above many systems provided currently.

### BRIEF DESCRIPTION OF THE DRAWINGS

Embodiments will now be described more fully with reference to the accompanying drawings, in which:

FIG. 1 is a general schematic diagram of a control system including an auxiliary controller according to an embodiment of the invention;

FIG. 2 is a flow chart of steps in a general method of operation of the auxiliary controller; and

FIG. 3 is a flow chart of steps undertaken by the auxiliary controller when in a setback mode.

### DETAILED DESCRIPTION OF THE EMBODIMENTS

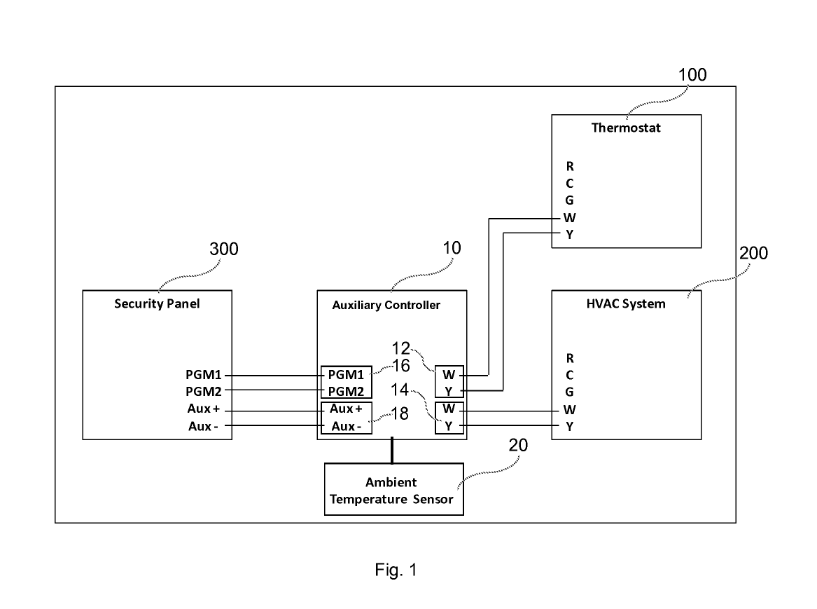

Turning now to FIG. 1, there is shown a control system 1 comprising a thermostat 2, an HVAC system 4, a security panel 6 of a security system, and an auxiliary controller 10 according to an embodiment of the invention.

The auxiliary controller 10 includes a thermostat interface 12 for receiving control signals by wire from thermostat 2, an HVAC system interface 14 for providing control signals by wire to HVAC system 4, and a security system interface 16 for receiving armed status signals by wire from the security panel 6. The auxiliary controller 10 also includes power terminals Aux + and Aux − for receiving 12 VDC power from a power source and providing the power to the components of the auxiliary controller. In this embodiment, the power terminals of the auxiliary controller 10 receive power from the Aux + and Aux − auxiliary power output terminals of the security panel 6 itself. The auxiliary controller 10 also includes an ambient temperature sensor 20, which in this embodiment is a thermistor, for use during a setback mode, as will be described.

Advantageously, in this embodiment, the security system and the HVAC system are optically isolated from each other so as to ensure that the operation of the security system is not compromised by the HVAC system, and vice versa.

The auxiliary controller 10 is configured to be installed on the return air duct of the HVAC system such that the thermistor can collect air temperature data from within the air duct and provide it back to the processing structure on the auxiliary controller 10. This enables the auxiliary controller 10 to maintain a predetermined temperature during a setback mode or enhanced setback mode as will be described. Preferably, a small hole is drilled from the outside to the inside of the return air duct, the thermistor is placed within the duct, and the leads from the thermistor are extended out of the small hole to the main circuit board of the auxiliary controller 10.

The control signals being received from thermostat 2 at the thermostat interface 12 are standard W (heating) and Y (cooling) ON/OFF signals. Thus, while the thermostat 2 is in heating mode (such as during cooler seasons), the thermostat 2 holds the Y signal at OFF (to keep the air conditioning off), and is simply providing an ON signal at the W terminal in the event that the thermostat generally detects that the ambient temperature is below the temperature it is programmed to maintain at a given time, and an OFF signal in the event that the ambient temperature is the same as or above the temperature it is programmed to maintain.

Similarly, while the thermostat 2 is in cooling mode (such as during warmer seasons), the thermostat 2 holds the W signal at OFF (to keep the furnace off), and is simply providing an ON signal at the Y terminal in the event that the thermostat generally detects that the ambient temperature is above the temperature it is programmed to maintain at a given time, and an OFF signal in the event that the ambient temperature is the same as or below the temperature it is programmed to maintain.

It will be understood that a given dwelling may have only an air conditioner, or only a furnace, or may have both. The description herein referring to an HVAC system is intended to refer to systems that provide either heating or cooling, or that provide both.

The control signals being provided to the HVAC system 4 via the HVAC system interface 14 take the same form as those received from the thermostat 2. In fact, they are simply routed via the relays from the thermostat 2 without being altered. However, as will be described, depending upon whether the security system has been armed, either the auxiliary controller simply routes all control signals received from the thermostat 2 to the HVAC system 4 via the HVAC system interface 14, or enters a setback mode including controlling the routing by allowing or denying passage of the control signals, in order to reduce the amount of energy consumed by the HVAC system 4.

When routing while the security system is disarmed, the auxiliary controller 10 always maintains a relay normally closed between the W terminal of the thermostat interface 12 and the W terminal of the HVAC system interface 14, and similarly always maintains a relay normally closed between the Y terminal of the thermostat interface 12 and the Y terminal of the HVAC system interface 14. In this way, cooling or heating control signals from the thermostat 2 follow a direct path through the respective relays to the HVAC system 4.

However, in the setback mode, the auxiliary controller 10 overrides the thermostatic control by controlling the relays such that the control signal path from the thermostat 2 to the HVAC system 4 is selectively broken. The auxiliary controller 10 thereby controls which control signals are passed to the HVAC system 4.

There are, in this embodiment, two types of armed status signals received at the security system interface. The first is an AWAY armed status signal, and the second is a STAY armed status signal. The AWAY and STAY modes of security systems are well known. In particular, the AWAY mode is for when the occupant(s) of the dwelling are going to be out of the home. In this event, an occupant when leaving the dwelling presses an AWAY button on the security system control panel (not shown), which arms the security system in full such that the security system becomes responsive to both internal and perimeter sensors such as motion, door and window sensors.

Alternatively, if the occupant wants simply to remain in the dwelling but arm the security system, the occupant presses the STAY button which causes the security system to be armed, but to be responsive only to perimeter sensors such as exterior door and window sensors. In this case, the motion sensors within the room(s) of the dwelling do not cause the security system to register an alert, and the occupant can therefore move freely within the dwelling without tripping an alarm.

In order to provide an AWAY armed status signals to the security system interface 16 when the security system has been placed in AWAY armed mode, the security system itself is pre-programmed, using a known technique, to simply set a steady minus (−) 12VDC (Volts, Direct Current) level on its PGM1 output line in the event that it is placed into the AWAY mode.

Similarly, in order to provide a STAY armed status signal to the security system interface 16 when the security system has been placed in STAY armed mode, the security system is pre-programmed, again using a known technique, to simply set a steady minus (−) 12VDC level on its PGM2 output line in the event that it is placed into the STAY mode.

The auxiliary controller 10 receives either the −12 VDC level on PGM1 or the −12 VDC on PGM2 indicating either AWAY mode or STAY mode has been invoked. The AWAY and STAY modes are mutually exclusive.

It will be understood that many security systems have programmable outputs such as PGM1 and PGM2 as described above. In fact, many security systems have more than two programmable outputs, such as eight programmable outputs PGM1 to PGM8. As such, the skilled reader will appreciate that, in embodiments using AWAY and STAY signals, any two programmable outputs of a security system may function as inputs to the auxiliary controller 10. For example, a security system's PGM1 and PGM8 outputs could be programmed to provide AWAY and STAY signals, respectively, while in such an instance programmable outputs PGM2 through PGM7 could each be programmed for some other functions in other systems, or simply not used at all. Which two of the programmable outputs are configured for use with the auxiliary controller 10 described herein would therefore be a function of the needs of a particular implementation.

Similarly, in embodiments using just an AWAY signal, or just a STAY signal, any one of PGM1 to PGM8 could be programmed accordingly to provide the signal to the auxiliary controller 10.

The auxiliary controller 10 further includes a processing structure, which in this embodiment is a single microprocessor operable at 1 MHz, a memory unit including 8 Kb of onboard non-volatile flash memory for storing processor-executable code including operating logic and operation parameters, a timer, two single-pole-single-throw (SPST) relays, multiple DIP (dual inline package) configuration switches for enabling the setting of configuration parameters for the auxiliary controller 10, and status and power indicator LEDs (Light Emitting Diodes).

As will be described now in further detail, the auxiliary controller 10 is responsive to receipt of an AWAY armed status signal or a STAY armed status signal at the security system interface to invoke a setback mode including controlling the routing of control signals from thermostat interface 12 to HVAC system interface 14 thereby to assume control of the HVAC system 4 itself. In the event that the security system is disarmed, the AWAY or STAY armed status signal—whichever is the case—ceases to be received at the security system interface 16 because the security system is pre-programmed to stop holding a −12 VDC level on PGM1 or PGM2. In this event, the processor causes the auxiliary controller 10 to exit the setback mode and resume routing of all of the control signals received from the thermostat 2 to the HVAC system 4.

The auxiliary controller 10 is capable of operating in either a heating mode or a cooling mode at any given time, depending upon whether a dwelling incorporates a heating system such as a furnace and/or a cooling system such as an air conditioner, and also depending upon the season and the preferences of the occupants. The auxiliary controller 10 achieves this simply by functioning to either route or not route the heating/cooling control signals from the thermostat 2 to the HVAC system 4 by either opening or closing the relays. As such, the auxiliary controller 10 does not need to be placed into a heating or cooling mode, as this is governed solely by which one of the W and Y paths the thermostat 2 is sending control signals, and the auxiliary controller 10 simply either routes or does not route the received control signals to the HVAC system 4.

Where the thermostat 2 is being used during a particular period to control a cooling system, the setback mode that is invoked when the security system is armed controls the HVAC system 4 to either shut off completely (by routing no control signals at all), or to operate at a predetermined temperature that is likely to be above that normally desired to be maintained by the occupant while present.

Where the HVAC system 4 is to be operated at a particular temperature, the ambient temperature is obtained by the auxiliary controller 10 from data provided by the temperature sensor 20. The auxiliary controller 10 only routes an “ON” control signal from the thermostat 2 to the HVAC system 4 (such as, for example, an air conditioning unit) if the ambient temperature is above the predetermined temperature at which the auxiliary controller 10 is set. That is, if the ambient temperature is above the temperature the thermostat 2 has been programmed to maintain, the thermostat 2 will send an “ON” control signal, but while the security system is armed this “ON” control signal will only be routed by the auxiliary controller 10 (by closing the corresponding relay) to the HVAC system 4 (in this case the air conditioning unit) in the event that the ambient temperature measure by the auxiliary controller 10 is above the predetermined temperature at which the auxiliary controller 10 is set. In this way, routing of cooling control signals is controlled by the auxiliary controller 10. In order to reduce energy consumption therefore, the predetermined temperature for cooling at which the auxiliary controller 10 is set should be above that at which the thermostat 2 is set.

Whether the HVAC system 4 is shut off or set at a particular temperature is configurable with use of a respective set of configuration switches. In this embodiment, there are two configuration switches available for this setting, providing the OFF option, along with options for three cooling setback temperatures. In this embodiment, the three cooling setback temperatures are 76 degrees Fahrenheit (F), 78° F., and 80° F. (or, 24 degrees Celsius (C), 26° C., and 27° C.). Thus, for example, if the thermostat 2 is typically programmed to maintain a temperature of 72 degrees for cooling during the day, any of the above temperature settings for the auxiliary controller 10 will be suitable. On the other hand, if for example the thermostat 2 is typically programmed to maintain a temperature of 77 degrees for cooling during the day, any of the 78° F. and 80° F. temperatures for the auxiliary controller 10 will be suitable.

Where the thermostat 2 is being used during a particular period to control a heating system, the setback mode that is invoked when the security system is armed controls the HVAC system 4 to operate at a predetermined temperature that is likely to be below that normally desired to be maintained by the occupant while present.

As is the case with cooling where the HVAC system is to be operated at a particular temperature, for heating, the ambient temperature is obtained by the auxiliary controller 10 from data provided by the temperature sensor 20. The auxiliary controller 10 only routes an “ON” control signal from the thermostat 2 to the HVAC system 4 (such as, for example, a furnace), if the ambient temperature is below the predetermined temperature at which the auxiliary controller 10 is set. That is, if the ambient temperature is below the temperature the thermostat 2 has been programmed to maintain, the thermostat 2 will send an “ON” control signal. However, while the security system is armed this “ON” control signal will only be routed by the auxiliary controller 10 (by closing the corresponding relay) to the HVAC system 4 (in this case the furnace) in the event that the ambient temperature measured by the auxiliary controller 10 is below the predetermined temperature at which the auxiliary controller 10 is set. In this way, routing of heating control signals is controlled by the auxiliary controller 10. In order to reduce energy consumption therefore, the predetermined temperature for heating at which the auxiliary controller 10 is set should be below that at which the thermostat 2 is set.

The particular temperature is configurable with use of a respective set of configuration switches. In this embodiment, there are two configuration switches available for this setting, providing options for four heating setback temperatures. In this embodiment, the four heating setback temperatures are 68 degrees Fahrenheit (F), 66° F., 64° F. and 62° F. (or, 20 degrees Celsius (C), 19° C., 18° C. and 17° C.).

Thus, for example, if the thermostat 2 is typically programmed for heating to maintain a temperature of 72 degrees during the day, any of the above temperature settings for the auxiliary controller 10 will be suitable. On the other hand, if the thermostat 2 is typically programmed for heating to maintain a temperature of 67 degrees during the day, any of the 66° F., 64° F. and 62° F. temperatures for the auxiliary controller 10 will be suitable.

In the event that the AWAY armed status signal is received, the setback mode is a daytime setback mode, and in the event that the STAY armed status signal is received, the setback mode is a nighttime setback mode. The auxiliary controller 10 is capable of being configured, using a respective configuration switch, to automatically exit the daytime setback mode and restore full control of the HVAC system 4 as described above back to the thermostat 2 after a predetermined amount of time since invoking the daytime setback mode has lapsed, as tracked by the timer. In this embodiment, a configuration switch enables configuration of the predetermined time, such that one of two times may be selected. In this embodiment, the two times are 6 hours and 8 hours. Thus, for example, if daytime restoration is enabled using its corresponding configuration switch, and 8 hours is selected using its corresponding configuration switch, the auxiliary controller 10 will automatically exit the daytime setback mode after having been in the daytime setback mode for 8 hours. This is done even if the security system is still armed.

Similarly, the auxiliary controller 10 is capable of being configured, using a respective configuration switch, to automatically exit the nighttime setback mode and restore full control of the HVAC system 4 as described above back to the thermostat 2 after a predetermined amount of time since invoking the nighttime setback mode has lapsed, as tracked by the timer. In this embodiment, a configuration switch enables configuration of the predetermined time, such that one of two times may be selected. In this embodiment, the two times are 6 hours and 8 hours. Thus, for example, if nighttime restoration is enabled using its corresponding configuration switch, and 6 hours is selected using its corresponding configuration switch, the auxiliary controller 10 will automatically exit the nighttime setback mode after having been in the nighttime setback mode for 6 hours. Again, this is done even if the security system is still armed.

The timer is employed for other advantageous functions. For example, in this embodiment a configuration switch enables or disables an exit delay such that the daytime setback mode is delayed for a predetermined amount of time from the time that the security system has provided the AWAY armed status signal to the security system interface 18. In this embodiment, the exit delay amount of time is 20 minutes.

Another advantageous function that employs the timer is an enhanced setback mode that will further reduce energy consumption in the event that the auxiliary controller 10 has been receiving an AWAY armed status signal for greater than a predetermined period of time. This is intended for use to further lower the temperature within the dwelling (when in a heating mode) or to further raise the temperature within the dwelling (when in a cooling mode) beyond the temperature at which the auxiliary controller 10 is maintaining the dwelling in the standard setback mode. The enhanced setback mode is invoked when it is determined by the auxiliary controller 10 that the occupants have been away for longer than a typical workday, such as over a weekend or for a week. In this embodiment, the enhanced setback mode lowers (when heating) or raises (when cooling) the setback temperature by 3 degrees Fahrenheit (3° F.). In this embodiment, the amount of time that must lapse before invoking the enhanced setback mode is fixed at 18 hours.

The timer is also used to establish a delay of 3 minutes between successive restarts of the HVAC system in order to prevent short cycling. This is advantageous for helping to maintain the useful operating life of the HVAC system components.

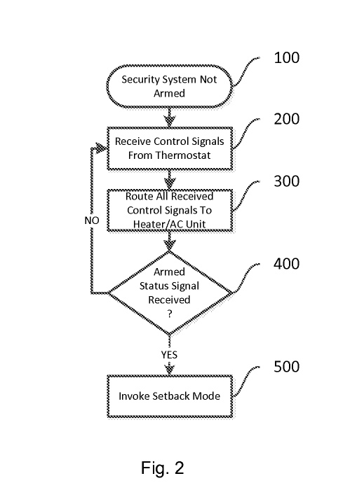

Turning now to FIG. 2, there is shown a flowchart of steps in a general method of operation of the auxiliary controller 10. The method begins while the security system is unarmed (step 100). The auxiliary controller 10 receives control signals from the thermostat 2 (step 200) via the thermostat interface 12, and routes all of the received control signals to the heater of AC Unit HVAC system component (step 300) depending upon whether heating or cooling is desired. If an armed status signal is received (step 400), then the setback mode is invoked (step 500). Otherwise, the process returns to step 200 to receive and route control signals to the HVAC system 4.

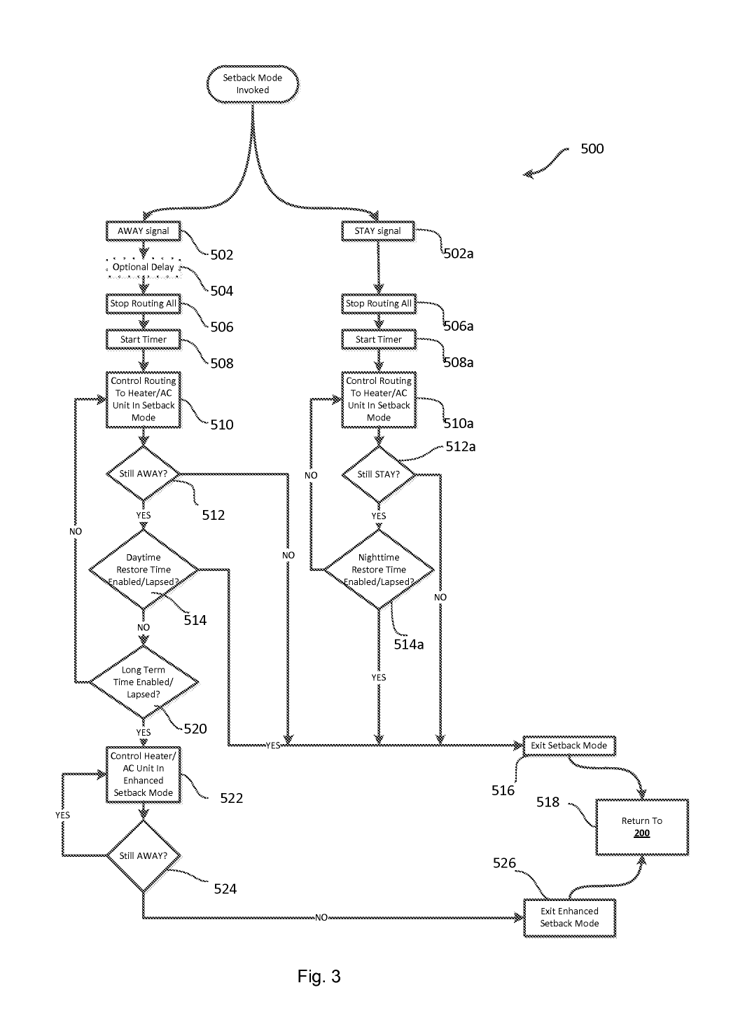

FIG. 3 is a flow chart of steps undertaken by the auxiliary controller 10 when in a setback mode. In the event that the armed status signal received at the security system interface 16 is an AWAY signal (step 502), the auxiliary controller 10 if configured with a daytime exit delay as described above will delay for the predetermined delay time (step 504) and then will stop necessarily routing all the control signals that are being received from the thermostat 2 to the HVAC system 4 (step 506). The timer is started (step 508), and the auxiliary controller 10 proceeds to control the routing of control signals to HVAC system 4 via the HVAC system interface 14 as described above (step 510). While operating in this daytime setback mode, if it is determined that the security system is no longer armed (step 512), the auxiliary controller 10 exits the daytime setback mode (step 516) and the process returns to step 200 (see FIG. 2) to receive and route all control signals from the thermostat 2 to the HVAC system 4. Otherwise, the processing structure determines whether a daytime restore is enabled (step 514) and, if so, whether the 6 or 8 hours has lapsed.

If the daytime restore time is enabled and has lapsed, then the auxiliary controller 10 exits the setback mode (step 516) and the process returns to step 200 (see FIG. 2) to receive and route all control signals from the thermostat 2 to the HVAC system 4. Otherwise, if the daytime restore time is not enabled, the auxiliary controller 10 proceeds to determine whether the enhanced/long term setback is enabled and the relevant time has lapsed (step 520). In the event that the enhanced setback is enabled and the relevant time (in this embodiment 18 hours) has lapsed, the auxiliary controller 10 invokes an enhanced setback mode and controls the HVAC system to operate for further energy savings by either further lowering (if heating) or further raising (if cooling) the maintained temperature (step 522). While in enhanced setback mode, the auxiliary controller 10 continues to monitor the armed status of the security system (step 524) and, if still set at AWAY, the auxiliary controller remains in the enhanced setback mode (step 522). If the security system is no longer armed, then the auxiliary controller 10 exits the enhanced setback mode (step 526) and returns to step 200 to receive and route all control signals from the thermostat 2 to the HVAC system 4.

When a setback mode is invoked, in the event that the armed status signal received at the security system interface 16 is a STAY signal (step 502a), the auxiliary controller 10 will enter the nighttime setback mode and immediately stop necessarily routing all of the control signals that are being received from the thermostat 2 to the HVAC system 4 (step 506a). The timer is started (step 508a), and the auxiliary controller 10 proceeds to control the routing of control signals to the HVAC system 4 via the HVAC system interface 14 as described above (step 510a). While operating in the nighttime setback mode, if it is determined that the security system is no longer armed (step 512), the auxiliary controller 10 exits the nighttime setback mode (step 516) and the process returns to step 200 (see FIG. 2) to receive and route all control signals from the thermostat 2 to the HVAC system 4. Otherwise, the processing structure determines whether a nighttime restore is enabled (step 514a) and, if so, whether the 6 or 8 hours has lapsed.

If the nighttime restore time is enabled and has lapsed, then the auxiliary controller 10 exits the setback mode (step 516a) and the process returns to step 200 (see FIG. 2) to receive and route all control signals from the thermostat 2 to the HVAC system 4.

The auxiliary controller 10 may comprise program modules for operation by the processing structure including but not limited to routines, programs, object components, data structures etc. and may be embodied as computer readable program code stored on a computer readable medium. The computer readable medium is any data storage device that can store data, which can thereafter be read by a computer system. Examples of computer readable media include for example read-only memory, random-access memory, flash memory, CD-ROMs, magnetic tape, optical data storage devices and other storage media.

Those skilled in the art will appreciate that the above embodiments are for exemplary purposes only, and other embodiments of this invention are also available.

For example, while the auxiliary controller 10 is described as being powered by auxiliary power from the security panel 6, it could be powered independently, by battery for example, or by an auxiliary power output of another device.

Also, the predetermined temperatures and predetermined times described herein for exiting setback modes or invoking enhanced set mode are exemplary and may be adjusted in such a manner as to not depart from the purpose of the invention.

Parameters indicated herein as not configurable, such as the enhanced setback mode time lapse of 18 hours, may be made configurable in an alternative embodiment. This may be done by building in an additional configuration switch, for example. Likewise, parameters indicated herein as configurable may, in an alternative embodiment, be fixed and therefore not configurable.

While configuration switches have been described as taking the form of DIP switches, other means for setting parameters may be employed. For example, a more sophisticated user interface having a control screen, or a simpler user interface having other types of switches, dials or pushbuttons may be employed.

While embodiments have been described that use both AWAY and STAY signals from a security system's programmable output, it is possible for an auxiliary controller to operate according to the principles described herein while receiving only one of these signals. For example, a security system may be capable only of providing one programmable output for an AWAY signal. Or, all but one of a security system's programmable outputs could be reserved for use with another system. The implementation of the auxiliary controller may be satisfactory with just use of one or the other of the AWAY and STAY signals, as each can be used by itself to trigger the auxiliary controller to operate in a setback mode in order to reduce energy consumption of the HVAC system.

Although embodiments of the invention have been described in detail, those of skill in the art will appreciate that variations and modifications may be made without departing from the purpose and scope of the invention as defined by the appended claims.

What is claimed is:

1. An auxiliary controller for an HVAC system comprising:
a thermostat interface for receiving control signals by wire from a thermostat;
an HVAC system interface for providing control signals by wire to an HVAC system;
a security system interface for receiving armed status signals by wire from a security system; and
processing structure configured to, while the security system is disarmed, permit routing of all control signals received from a thermostat to an HVAC system and, upon arming of the security system, invoke a setback mode including controlling the routing to reduce energy consumption.

2. The auxiliary controller of claim 1, wherein in the event that the HVAC system is being used for cooling, while in the setback mode the processing structure controls the HVAC system to be either OFF, or to operate at a predetermined temperature.

3. The auxiliary controller of claim 1, wherein in the event that the HVAC system is being used for heating, while in the setback mode the processing structure controls the HVAC system to operate at a predetermined temperature.

4. The auxiliary controller of claim 1, comprising a plurality of configuration switches for enabling the setting of setback mode parameters.

5. The auxiliary controller of claim 1, wherein the setback mode is a daytime setback mode in the event that an AWAY armed status signal is received, and the setback mode is a nighttime setback mode in the event that a STAY armed status signal is received.

6. The auxiliary controller of claim 5, wherein an AWAY armed status signal is considered received when there is about a −12 VDC level at a first terminal of the security system interface.

7. The auxiliary controller of claim 6, wherein the STAY armed status signal is considered received when there is about a −12 VDC level at a second terminal of the security system interface.

8. The auxiliary controller of claim 1, wherein the processing structure causes the auxiliary controller to automatically exit the setback mode in the event that the security system is disarmed, including resuming routing of all control signals.

9. The auxiliary controller of claim 5, further comprising a daytime restore configuration switch for configuring the processing structure to automatically exit the daytime setback mode in the event that the auxiliary controller has been in the daytime setback mode for a first predetermined time amount.

10. The auxiliary controller of claim 9, further comprising a nighttime restore configuration switch for configuring the processing structure to automatically exit the nighttime setback mode in the event that the auxiliary controller has been in the nighttime setback mode for a second predetermined time amount.

11. The auxiliary controller of claim 2, further comprising:
an enhanced setback mode configuration switch for configuring the processing structure to enter an enhanced setback mode in the event that the security system has had an AWAY armed status for a predetermined amount of time,
wherein, while in the enhanced setback mode, the processing structure causes the HVAC system to operate at a temperature that is higher than the predetermined temperature thereby to further reduce energy consumption.

12. The auxiliary controller of claim 3, further comprising:
an enhanced setback mode configuration switch for configuring the processing structure to invoke an enhanced setback mode in the event that the security system has had an AWAY armed status for a predetermined amount of time,
wherein, while in the enhanced setback mode, the processing structure causes the HVAC system to operate at a temperature that is lower than the predetermined temperature thereby to further reduce energy consumption.

13. The auxiliary controller of claim 1, further comprising a delay configuration switch for configuring the processing structure to delay entering the setback mode for a predetermined amount of time.

14. The auxiliary controller of claim 1, further comprising a thermistor in communication with the processing structure for providing ambient temperature data for operation in the setback mode.

15. A method of operating an auxiliary controller for an HVAC system comprising:
receiving control signals at the controller by wire from a thermostat;
routing all received control signals by wire from the controller to an HVAC system; and
in the event that an armed status signal is received by wire at the controller from a security system, invoking a setback mode including controlling the routing to reduce energy consumption.

16. The method of claim 15, further comprising:
automatically exiting the setback mode in the event that the armed status signal ceases to be received from the security system.

17. The method of claim 15, wherein the HVAC system is being used for cooling, and assuming control comprises controlling the HVAC system to be either OFF, or to operate at a predetermined temperature.

18. The method of claim 15, wherein the HVAC system is being used for heating, and assuming control comprises controlling the HVAC system to operate at a predetermined temperature.

19. The method of claim 15, wherein the setback mode is a daytime setback mode in the event that an AWAY armed status signal is received, and the setback mode is a nighttime setback mode in the event that a STAY armed status signal is received.

20. The method of claim 19, further comprising:
automatically exiting the daytime setback mode in the event that the auxiliary controller has been in the daytime setback mode for a first predetermined time amount.

21. The method of claim 19, further comprising:
automatically exiting the nighttime setback mode in the event that the auxiliary controller has been in the nighttime setback mode for a second predetermined time amount.

22. The method of claim 15, further comprising:
invoking an enhanced setback mode in the event that an armed status signal has been received from the security system for a predetermined amount of time,
while in the enhanced setback mode the auxiliary controller operates the HVAC system at a temperature that is higher or lower than the predetermined temperature thereby to further reduce energy consumption.

23. The method of claim 22, wherein the temperature in the enhanced setback mode is higher than the predetermined temperature in the event that the HVAC system is being used for cooling.

24. The method of claim 22, wherein the temperature in the enhanced setback mode is lower than the predetermined temperature in the event that the HVAC system is being used for heating.

25. The method of claim 15, further comprising delay invoking the setback mode for a predetermined amount of time.

26. The method of claim 15, further comprising receiving ambient temperature data from a thermistor for operation in the setback mode.
